(19) United States
(12) Patent Application Publication
(10) Pub. No.: US 2024/0035108 A1
(43) Pub. Date: Feb. 1, 2024

(54) GRAIN ORIENTED ELECTRICAL STEEL SHEET AND METHOD FOR MANUFACTURING SAME

(71) Applicant: POSCO Co., Ltd, Pohang-si, Gyeongsangbuk-do (KR)

(72) Inventors: Kyungjun Ko, Pohang-si, Gyeongsangbuk-do (KR); Sangwoo Lee, Pohang-si, Gyeongsangbuk-do (KR)

(73) Assignee: POSCO Co., Ltd, Pohang-si, Gyeongsangbuk-do (KR)

(21) Appl. No.: 18/265,908

(22) PCT Filed: Dec. 17, 2021
(86) PCT No.: PCT/KR2021/019329

§ 371 Date: Jul. 13, 2023

(30) Foreign Application Priority Data
Dec. 21, 2020 (KR) 10-2020-0179363

(51) Int. Cl. C21D 9/46; C22C 38/00; C22C 38/02; C22C 38/04; C22C 38/06; C22C 38/12; C22C 38/14; C21D 8/12; C21D 6/00; C21D 1/76; H01F 1/147

(52) U.S. Cl. CPC C21D 9/46; C22C 38/001; C22C 38/002; C22C 38/008; C22C 38/02; C22C 38/04; C22C 38/06; C22C 38/12; C22C 38/14; C21D 8/1233; C21D 8/1272; C21D 6/005; C21D 6/008; C21D 1/76; H01F 1/14766; C21D 2201/05; C22C 2202/02

(57) ABSTRACT

A method for manufacturing a grain oriented electrical steel sheet according to an embodiment of the present invention comprises the steps of: hot-rolling a slab to prepare a hot-rolled sheet, the slab containing, in weight %, Si: 2.5 to 4.0%, C: 0.03 to 0.09%, Al: 0.015 to 0.040%, Mn: 0.04 to 0.15%, S: 0.01% or less (0% excluded), N: 0.002 to 0.012%, and the balance being Fe and other inevitably incorporated impurities; cold-rolling the hot-rolled sheet to prepare a cold-rolled sheet; performing primary recrystallization annealing on the cold-rolled sheet; and performing secondary recrystallization annealing on the cold-rolled sheet that has been primary recrystallization annealed.

### TECHNICAL FIELD

One embodiment of the present invention relates to a grain oriented electrical steel sheet and a method for manufacturing the same. Specifically, the present invention relates to a grain-oriented electrical steel sheet with improved magnetic uniformity by controlling the amount of residual Al in the slab and a nitriding amount inside the steel sheet, and a manufacturing method thereof.

### BACKGROUND ART

A grain oriented electrical steel is used as an iron core material for stationary equipment such as transformers, motors, generators, and other electronic devices. Since a final product of grain oriented electrical steel sheet has a texture in which an orientation of crystal grains is oriented in a (110)[001] direction, and thus, has extremely excellent magnetic properties in the rolling direction, the final product may be used as an iron core material for a transformer, a motor, a generator, other electronic devices, and the like. In order to reduce energy loss, the final product requires low core loss and high magnetic flux density to down-size the generator.

The core loss of the grain oriented electrical steel sheet is divided into hysteretic loss and eddy current loss, and among those, in order to reduce the eddy current loss, efforts such as increasing specific resistivity and reducing product plate thickness are required. Although there is a difficulty in rolling the grain oriented electrical steel sheet, which is a difficult-to-roll product, into an ultra-thin material in a direction of reducing a thickness of a product sheet, the biggest difficulty and problem to overcome in manufacturing ultra-thin products with very low core loss properties are that agglomeration of Goss orientation, which is a secondary recrystallization structure of the grain oriented electrical steel sheet, keeps very strong.

Looking at the problems in rolling in manufacturing the ultra-thin products, it is known that an optimal reduction ratio is usually around 90% when manufacturing grain oriented electrical steel sheet via a low-temperature heating method and a one-time steel cold-rolling process. In order to secure 90% cold-rolling rate, a hot-rolled sheet thickness is required to be hot-rolled to a thickness of 2.0 mm or less. As the hot-rolled thickness becomes thinner, a high reduction rate is required, and productivity decreases due to maintenance of hot-rolled temperature, shape of an edge portion of a hot-rolled sheet such as edge scab, a shape of top and tail portions of a coil, or the like. In addition, as the length of the hot-rolled coil increases, a difference in rolling time between the top and tail portions of the coil and a difference in hot-rolling temperature inevitably occur, which is more disadvantageous in forming uniform fine precipitates in the longitudinal direction of the coil. In addition, due to temperature deviations caused by a temperature of a skid contact part being lower than a temperature of a non-contact part during the movement of the slab in the hot-rolling reheating furnace when heating the slab for hot-rolling, a difference in solid solution precipitates (fine precipitates) in the longitudinal direction of the hot-rolled sheet inevitably occurs. This difference causes a problem of causing deviations in magnetic properties of the final product.

A more important problem is that as the product thickness becomes thinner, the loss of precipitates from the surface increases, in particular, in a section where the secondary recrystallization of the Goss orientation appears during secondary recrystallization annealing process, making it difficult to keep the directness of the Goss orientation strong. This is a problem directly related to the magnetic properties of the product, making it difficult to secure very low core loss properties by manufacturing the ultra-thin products.

As a method for overcome precipitate loss, a method for preventing precipitate loss by increasing a fraction of N₂ gas during a secondary recrystallization annealing process has been proposed, but has a problem of causing surface defects such as a nitrogen outlet on a surface of the product sheet.

An economical manufacturing method using simultaneous decarburization nitriding method has also been proposed. It was clarified that there was a difference between a surface grain size and a center layer grain size in manufacturing a decarburized sheet by the simultaneous decarburization nitriding method, and it was suggested that the difference needs to be controlled within a certain range.

A technique for dramatically improving magnetism by including segregated elements such as Sb, P, and Sn has also been proposed. When manufacturing the ultra-thin products by adding more segregated elements, the segregated elements were used as auxiliary inhibitors to compensate for the loss of precipitates. When an excessive amount of segregated elements is added, ultra-thin rolling is difficult. When the excessive amount of the segregated elements is added, an oxide layer becomes non-uniform and thin, so properties of the base coating are inferior and the loss of precipitates is further caused, thereby making it impossible to stably secure magnetism.

In the primary recrystallization annealing process in the manufacturing of the ultra-thin products, a method for controlling oxidation ability and nitriding treatment of a front end portion has also been proposed. However, in manufacturing the ultra-thin products, there was a problem that the effect of loss of precipitates was very sensitive.

In addition, a method for adding Cr to a slab and adjusting a nitriding gas input amount at the front and rear end portions in the primary recrystallization annealing process has been proposed. However, this method has a problem in that the amount of nitrogen in a thickness direction of the steel sheet is uniformly maintained, but AlN precipitates are non-uniformly distributed, so deviations in magnetic properties still exist. In addition, by adding Cr, a thickness of the base coating becomes thicker as a depth of the oxide layer increases, and a problem also occurred in the manufacturing of the ultra-thin materials in which the occupied ratio of the coating layer increases.

### DISCLOSURE

### Technical Problem

The present invention attempts to provide a grain oriented electrical steel sheet and a method for manufacturing the same. More particularly, the present invention attempts to provide a grain-oriented electrical steel sheet with improved magnetic uniformity by controlling the amount of residual Al in a slab and a nitriding amount inside the steel sheet, and a method for manufacturing the same.

### Technical Solution

According to an embodiment of the present invention, a method for manufacturing a grain oriented electrical steel sheet includes: hot-rolling a slab to prepare a hot-rolled sheet, the slab containing, in weight %, Si: 2.5-4.0%, C: 0.03 to 0.09%, Al: 0.015 to 0.040%, Mn: 0.04 to 0.15%, S: 0.01% or less (0% excluded), N: 0.002 to 0.012%, and the balance being Fe and other inevitably incorporated impurities and satisfying the following Expressions 1 and 2; cold-rolling the hot-rolled sheet to prepare a cold-rolled sheet; performing primary recrystallization annealing on the cold-rolled sheet; and performing secondary recrystallization annealing on the cold-rolled sheet that has been primary recrystallization annealed.

in which, after the primary recrystallization annealing, the following Expression 3 is satisfied.

[Al]−27/14×[N]≥0.0240 [Expression 1]

[Al]/[N]≤14 [Expression 2]

(In Expressions 1 and 2, [Al] and [N] denote the content (wt %) of Al and N in the slab, respectively.)

[Nₜₒₜ]−[N_{1/4t-3/4t}]≤60×(10×[t]−1) [Expression 3]

(In Expression 3, [Nₜₒₜ] denotes the nitrogen content (ppm) in the entire steel sheet, [N_{1/4-3/4t}] denotes the nitrogen content (ppm) at ¼ to ¾ point of a total thickness of the steel sheet, and [t] denotes a thickness of the cold-rolled sheet (mm).)

The slab may further contain 0.002 to 0.01 wt % of at least one of Ti and V alone or in combination thereof.

The slab may further contain 0.03 to 0.15 wt % of Sn and Sb in combination, and 0.01 to 0.05 wt % of P.

The slab may further contain at least one of Cr: 0.01 wt % or less and Ni: 0.01 wt % or less.

The primary recrystallization annealing may include a preceding process and a subsequent process, and a nitriding gas input amount A in the preceding process with respect to a total nitriding gas input amount B in the primary recrystallization annealing may satisfy Expression 4 below.

0.055≤[A]/[B]≤[t] [Expression 4]

(In Expression 4, a unit of the nitriding gas input amount is Nm³/hr, and [t] denotes the thickness of the cold-rolled sheet (mm).)

An execution time of the preceding process may be 10 to 80 seconds, and an execution time of the subsequent process may be 30 to 100 seconds.

The preceding and subsequent processes may be performed at a temperature of 800 to 900° C.

The preceding and subsequent processes may be performed in an atmosphere having an oxidation ability (PH₂O/PH₂) of 0.5 to 0.7.

After the primary recrystallization annealing, the steel sheet may satisfy Expression 5 below.

1≤[G_{1/4t}]−[G_{1/2t}]≤3 [Expression 5]

(In Expression 5, [G_{1/4t}] denotes an average grain size μm measured at ¼ point of the total thickness of the steel sheet, and [G_{1/2t}] denotes average grain size μm measured at ½ point of the total thickness of the steel sheet)

After the secondary recrystallization annealing, the steel sheet may satisfy Expression 6 below.

[D_{S}]/[D_{L}]≤0.1 [Expression 6]

(In Expression 6, [D_{S}] denotes the number of crystal grains having a particle diameter of 5 mm or less, and [D_{L}] denotes the number of crystal grains having a particle diameter of more than 5 mm.)

After the secondary recrystallization annealing, a ratio of maximum Al luminous intensity to maximum Mg luminous intensity in the base coating layer may be 0.05 to 0.10.

According to another embodiment of the present invention, a grain oriented electrical steel sheet includes an electrical steel sheet substrate containing, in weight %, Si: 2.5 to 4.0%, C: 0.005% or less (0% excluded), Al: 0.015 to 0.040%, Mn: 0.04 to 0.15%, S: 0.01% or less (0% excluded), N: 0.0100% or less (0% excluded), and the balance being Fe and other inevitably incorporated impurities and a base coating layer located on the electrical steel sheet substrate, in which a ratio of maximum Al luminous intensity to maximum Mg luminous intensity in the base coating layer is 0.05 to 0.10.

### Advantageous Effects

According to an embodiment of the present invention, it is possible to improve magnetism by adjusting Al and N contents in a slab and controlling a nitriding amount according to a thickness.

### DESCRIPTION OF THE DRAWINGS

FIG. 1 is a schematic view of a glow discharge luminescence spectroscopy (GDS) result of a grain oriented electrical steel sheet surface according to an embodiment.

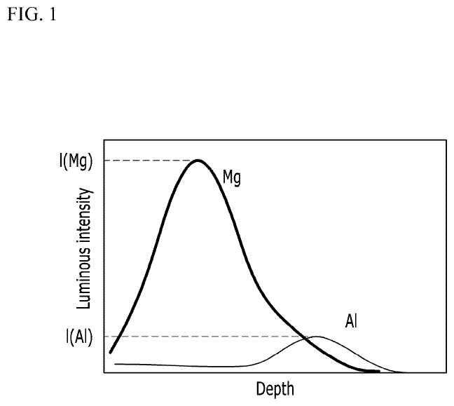

### MODE FOR INVENTION

The terms first, second, third, and the like are used to describe, but are not limited to, various parts, components, areas, layers and/or sections. These terms are used only to distinguish a part, component, region, layer, or section from other parts, components, regions, layers, or sections. Accordingly, a first part, a component, an area, a layer, or a section described below may be referred to as a second part, a component, a region, a layer, or a section without departing from the scope of the present disclosure.

Terminologies used herein are to mention only a specific embodiment, and do not to limit the present invention. Singular forms used herein include plural forms as long as phrases do not clearly indicate an opposite meaning. The meaning “including” used in the present specification concretely indicates specific properties, areas, integer numbers, steps, operations, elements, and/or components, and is not to exclude presence or addition of other specific properties, areas, integer numbers, steps, operations, elements, and/or components thereof.

When a part is referred to as being “above” or “on” other parts, it may be directly above or on other parts, or other parts may be included in between. In contrast, when a part is referred to as being “directly above” another part, no other part is involved in between.

All terms including technical terms and scientific terms used herein have the same meaning as the meaning generally understood by those skilled in the art to which the present invention pertains unless defined otherwise. Terms defined in commonly used dictionaries are additionally interpreted as having meanings consistent with related technical literature and currently disclosed content, and are not interpreted in ideal or very formal meanings unless defined.

In addition, unless otherwise specified, % means wt %, and 1 ppm is 0.0001 wt %.

In an embodiment, further including additional elements means that the balance of iron (Fe) is replaced and included as much as the additional amount of the additional elements.

Hereinafter, an embodiment will be described in detail so that a person of ordinary skill in the art to which the present invention pertains can easily implement the present invention. As those skilled in the art would realize, the described embodiments may be modified in various different ways, all without departing from the spirit or scope of the present invention.

A method for manufacturing a grain oriented electrical steel sheet according to an embodiment of the present invention includes: manufacturing a hot-rolled sheet by hot-rolling a slab; manufacturing a cold-rolled sheet by cold-rolling the hot-rolled sheet; performing primary recrystallization annealing on the cold-rolled sheet; and performing secondary recrystallization annealing on the cold-rolled sheet for which the primary recrystallization annealing has been completed.

Hereinafter, each step will be described in detail.

First, the slab is hot-rolled to manufacture the hot-rolled steel sheet.

Hereinafter, slab alloy components will be described.

The slab contains, in weight %, Si: 2.5 to 4.0%, C: 0.03 to 0.09%, Al: 0.015 to 0.040%, Mn: 0.04 to 0.15%, S: 0.01% or less (0% excluded), N: 0.002 to 0.012%, and the balance being Fe and other inevitably incorporated impurities.

Si: 2.50 to 4.00 wt %

Silicon (Si) increases a specific resistance of a grain oriented electrical steel sheet material and serves to lower core loss, that is, iron loss. When the Si content is too small, the specific resistance may decrease and thus the core loss may deteriorate. When the Si content is too high, brittleness of steel increases and toughness decreases, so the occurrence rate of sheet breakage may increase during the rolling process, weldability may deteriorate and thus a load may be generated in the cold-rolling operation, a sheet temperature required for pass aging during cold-rolling may not be reached, and secondary recrystallization formation may become unstable. Accordingly, the Si content may be 2.5 and 4.0 wt %. More specifically, Si content may be 3.0 to 3.5 wt %.

C: 0.030 to 0.090 wt %

Carbon (C) is an element that induces the formation of an austenite phase, and as the C content increases, the ferrite-austenite phase transformation is activated during the hot-rolling process, and the long-stretched hot-rolled strip structure formed during the hot-rolling process increases, so the growth of ferrite grains is inhibited during the rolled sheet annealing process. In addition, as the C content increases, the texture after cold-rolling is improved, in particular, the Goss fraction increases, by the increase in the stretched hot-rolled strip structure, which has higher strength than the ferrite structure, and the refinement of the initial grains of the hot-rolled sheet annealed structure, which is the starting structure of cold-rolling. This is considered that the pass aging effect during the cold-rolling increases due to the residual C present in the steel sheet after the hot-rolled sheet annealing, thereby increasing the Goss fraction in the primary material crystal grains. Therefore, the higher the C content, the better, but decarburization annealing time becomes longer during decarburization annealing and productivity is damaged. When the decarburization in the initial stage of heating is not sufficient, the primary recrystallized grains become non-uniform and the secondary recrystallization becomes unstable. In addition, since magnetic properties may be inferior due to magnetic aging, the C content may be limited to the range of 0.03 to 0.09 wt %. More specifically, C may be contained in the range of 0.050 to 0.070 wt %. As described above, carbon is removed by decarburization during primary recrystallization annealing, and the final drafted grain oriented electrical steel sheet may contain 0.005 wt % or less of C.

Al: 0.015 to 0.040 wt %

Aluminum (Al) combines with N to precipitate as AlN, but nitrides in the form of (Al, Si, Mn) N and AlN, which are fine precipitates, are formed during the annealing for decarburization and nitriding, which serves to inhibit the growth of strong crystal grains. A certain amount of Al dissolved in this way is required. When the content is too small, the effect of inhibiting the growth of crystal grains may not be sufficient because the number and volume fraction of precipitates formed are low. When too much Al is included, the precipitates grow coarsely, and the effect of inhibiting the growth of crystal grains is reduced. Accordingly, Al may be contained in an amount of 0.015 to 0.040 wt %. More specifically, Al may be contained in an amount of 0.0200 to 0.0380 wt %.

Mn: 0.040 to 0.150 wt %

Manganese (Mn) has the effect of reducing core loss by increasing specific resistance in the same way as Si, and is an element that reacts with nitrogen introduced by nitriding treatment together with Si to form precipitates of (Al,Si,Mn)N, thereby suppressing the growth of primary recrystallized grains and causing the secondary recrystallization. In addition, Mn improves primary recrystal grain uniformity by forming sulfide precipitates with Cu, and partially serves as an auxiliary inhibitor in the formation of secondary recrystallization. However, when too much Mn is included, the slab reheating temperature should be increased to adjust the (Cu,Mn)S fine precipitates. In this case, the primary recrystallized grains become extremely fine, and the temperature of the primary recrystallization annealing should be raised above the range, causing grain non-uniformity, so the upper limit may be limited to 0.15 wt %.

In addition, when excessive Mn is added, a large amount of (Fe, Mn) and Mn oxides are formed on the surface of the steel sheet in addition to Fe₂SiO₄, to hinder the formation of the base coating formed during secondary recrystallization annealing, thereby degrading the surface quality, and causing the phase transformation non-uniformity between ferrite and austenite in the primary recrystallization annealing process. As a result, the size of the primary recrystallized grains becomes non-uniform, so the secondary recrystallization becomes unstable.

N: 0.0020 to 0.0120 wt %

Nitrogen (N) is an element that refines crystal grains by reacting with Al or the like. When these elements are properly distributed, as described above, they may be helpful in securing an appropriate primary recrystallized grain size by appropriately refining the structure after cold-rolling. However, when the content is excessive, the primary recrystal grains are excessively refined, and as a result, the driving force that causes the growth of crystal grains during secondary recrystallization increases due to the fine crystal grains to make grains grow in an undesirable orientation, which is not preferable. In addition, when too much N is added, the primary recrystal grains become excessively refined, and as a result, the secondary recrystallization may be formed in an undesirable orientation due to the fine crystal grains, resulting in poor magnetic properties. Therefore, N is set to 0.0120 wt % or less. Meanwhile, when the N content is too small, the effect of inhibiting primary recrystallization is too weak, so the effect of inhibiting the stable growth of crystal grains may not be obtained. Therefore, 0.0020 to 0.0120 wt % of N may be contained in the slab. More specifically, N may be contained in an amount of 0.0025 to 0.0100 wt %. Since N is partially removed during the secondary recrystallization annealing process, the finally manufactured grain oriented electrical steel sheet may contain 0.0100 wt % or less of N.

The Al and N content in the slab may satisfy Equations 1 and 2 below.

[Al]−27/14×[N]≥0.0240 [Expression 1]

[Al]/[N]≤14 [Expression 2]

(In Expressions 1 and 2, [Al] and [N] denote the content (wt %) of Al and N in the slab, respectively.)

When the left side of Equation 1 is less than 0.0240%, the amount of AlN precipitates formed by nitriding before the secondary recrystallization annealing is insufficient, and the fine AlN precipitates remaining in ultra-thin hot-rolling are non-uniformly distributed, thereby increasing the deviation in magnetic properties. More specifically, the left side of Equation 1 may be 0.0240 to 0.3000%.

When the left side of Equation 2 is too large, an inhibitory force as an inhibitor of AlN is not sufficient, which may lead to coarsening of crystal grains in the surface layer and center layer of the steel sheet. More specifically, the left side of Equation 2 may be 5.0 to 13.0.

S: 0.0100 wt % or Less

Sulfur (S) is an element with high solid solution temperature and severe segregation during the hot-rolling, and it is desirable to avoid containing sulfur (S) as much as possible, but it is a kind of inevitable impurities contained during steelmaking. In addition, since S forms (Mn, Cu)S and affects the uniformity of primary recrystal grains, the S content may be limited to 0.0100 wt % or less. More specifically, S may be contained in the range of 0.0010 to 0.0080 wt %.

The slab may further contain 0.002 to 0.01 wt % of at least one of Ti and V alone or in combination thereof. When Ti and V are included alone, Ti and V each alone contain 0.002 to 0.01 wt %, and when both Ti and V are included, the amount of Ti+V may be 0.002 to 0.01 wt %. More specifically, the slab may further include 0.0030 to 0.0070 wt % of at least one of Ti and V alone or in combination thereof.

Ti: 0.002 to 0.01 wt %

Titanium (Ti) is a strong nitride forming element, and becomes TiN in the pre-hot rolling step, lowers the N content, and suppresses the growth of crystal grains through fine precipitation. When the titanium is added within an appropriate range, it shows the effect of inhibiting the growth of crystal grains by the formation of TiN precipitates and the effect of reducing the deviation in grain size within the coil by reducing fine precipitates of AlN.

V: 0.002 to 0.01 wt %

Vanadium (V) is a carbide and nitride forming element and finely precipitated, and inhibits the growth of crystal grains. When the vanadium (V) is added within an appropriate range, it shows the effect of reducing the deviation in the grain size in the coil by the effect of inhibiting the growth of crystal grains by the formation of fine precipitates.

The slab may further contain 0.03 to 0.15 wt % of Sn and Sb in combination, and 0.01 to 0.05 wt % of P.

Sn and Sb: 0.030 to 0.080 wt %

Tin (Sn) and antimony (Sb) are segregated elements of the grain boundary, and is known as a crystal growth inhibitor because they are elements that hinder the movement of the grain boundary. In addition, by increasing the crystal grain fraction of the Goss orientation in the primary recrystallized texture, the Goss orientation nucleus that grows into the secondary recrystallized texture increases, so the size of the secondary recrystallized microstructure decreases. As a result, the smaller the grain size, the smaller the eddy current loss, so the core loss of the final product decreases. When the total amount of Sn and Sb is too small, there is no effect of addition. When the total amount is too large, the crystal grain growth inhibitory force increases too much, so the crystal grain size of the primary recrystallized microstructure should be reduced to relatively increase the crystal grain growth driving force, so the decarburization annealing should be performed at a low temperature. As a result, it is not possible to secure a good surface because it may not be controlled with an appropriate oxide layer. More specifically, the slab may further include 0.040 to 0.070 wt % of at least one of Sn and Sb alone or in combination thereof.

P: 0.010 to 0.050 wt %

Phosphorus (P) is an element that shows an effect similar to Sn and Sb, is segregated on the grain boundary to hinder the movement of the grain boundary and at the same time can play an auxiliary role of inhibiting the growth of crystal grains. In addition, the phosphorus (P) has an effect of improving a {110}<001> texture in terms of the microstructure. When the P content is too small, there is no effect of addition, and when the P content is too much, brittleness may increase and rollability may greatly deteriorate. More specifically, P may be contained in an amount of 0.015 to 0.045 wt %.

The slab may further contain at least one of Cr: 0.01 wt % or less and Ni: 0.01 wt % or less.

Cr: 0.01 wt % or Less, Ni: 0.01 wt % or Less

Chromium (Cr) and nickel (Ni) are disadvantageous in obtaining stable magnetism in the manufacturing of ultra-thin products in which the thickness of the base coating increases as the depth of the oxide layer increases, and the ratio of the coating layer to the thickness increases, so the upper limits thereof are limited to 0.01 wt %, respectively.

Impurity Element

In addition to the above elements, impurities such as Zr and V that are inevitably incorporated may be included. Zr, V, etc., are strong carbonitride forming elements, and therefore, are preferably not added as much as possible, and each should be contained at 0.01 wt % or less.

In addition to the above-described elements, the rest includes iron (Fe). In an embodiment of the present invention, the addition of elements other than the above-described alloy components is not excluded, and these elements may be variously contained within a range that does not impair the technical spirit of the present invention. When additional elements are further contained, they are contained in place of Fe which is the balance.

A step of heating the slab to 1230° C. or lower may be further included before the step of manufacturing the hot-rolled sheet. Through this step, the precipitate may be partially dissolved. In addition, since the coarse growth of the columnar structure of the slab is prevented, it is possible to prevent cracks from occurring in the width direction of the plate in the subsequent hot-rolling process, thereby improving the real yield. When the slab heating temperature is too high, the melting of the surface of the slab may repair the heating furnace and shorten the life of the heating furnace. More specifically, the slab may be heated to 1130 to 1200° C. It is also possible to hot-roll a continuously cast slab as it is without heating the slab.

In the step of manufacturing the hot-rolled sheet, the hot-rolled sheet having a thickness of 1.8 to 2.3 mm may be manufactured by hot-rolling.

After manufacturing the hot-rolled sheet, a step of hot-rolled sheet annealing of the hot-rolled sheet may be further included. The step of annealing the hot-rolled sheet may be performed by heating to a temperature of 950 to 1,100° C., cracking at a temperature of 850 to 1,000° C. and then cooling.

Next, the cold-rolled sheet is manufactured by cold-rolling the hot-rolled sheet.

The cold-rolling may be performed through one-time steel cold-rolling or through a plurality of passes. It may give a pass aging effect through warm rolling at a temperature of 200 to 300° C. one or more times during rolling, and may be manufactured to a final thickness of 0.14 to 0.25 mm. The cold-rolled sheet is subjected to decarburization and recrystallization of deformed structure in the primary recrystallization annealing process and nitriding treatment through nitriding gas.

Next, the cold-rolled sheet is subjected to the primary recrystallization annealing.

In one embodiment of the present invention, the step of performing the primary recrystallization annealing is divided into a preceding process and a subsequent process, so the nitriding gas input amount in the preceding and subsequent processes is different.

In this case, the preceding and subsequent processes are performed in the soaking step. The primary recrystallization annealing step comprises a temperature rising step and the soaking step.

The preceding and subsequent processes may be performed in a separate soaking zone, or a screen blocking the flow of nitriding gas to the front and rear ends may be performed in a soaking zone.

By appropriately inputting the nitriding gas in the preceding and subsequent processes, ultimately, the magnetism is improved by appropriately growing crystal grains on a surface layer and making the nitriding smoothly into the steel sheet.

Specifically, a nitriding gas input amount A in the preceding process to the total nitriding gas input amount B satisfies Expression 1 below.

0.05≤[A]/[B]≤[t] [Expression 1]

(In Expression 1, a unit of the nitriding gas input amount is Nm³/hr, and [t] denotes the thickness of the cold-rolled sheet (mm).)

When the nitriding gas input amount in the preceding process is too small, nitrogen does not penetrate into the steel sheet and exists only on the surface layer, causing the poor magnetism. Conversely, when the nitriding gas input amount in the preceding process is too large, the growth of crystal grains in the surface layer of the steel sheet is greatly suppressed, causing the poor magnetism.

More specifically, the nitriding gas input amount in the preceding process may be 0.05 to 3 Nm³/hr, and the nitriding gas input amount in the subsequent process may be 1 to 10 Nm³/hr.

The nitriding gas may be used without limitation as long as nitrogen may be decomposed at the temperature in the primary recrystallization annealing process and permeate into the steel sheet. Specifically, the nitriding gas may include at least one of ammonia and amine.

An execution time of the preceding process may be 10 to 80 seconds, and an execution time of the subsequent process may be 30 to 100 seconds.

The soaking temperature of the primary recrystallization annealing step, that is, the preceding and subsequent processes may be performed at a temperature of 800 to 900° C. When the temperature is too low, the primary recrystallization may not be performed or the nitriding may not be performed smoothly. When the temperature is too high, the primary recrystallization grows too large, causing the poor magnetism.

The decarburization may also be achieved in the primary recrystallization annealing step. The decarburization may be performed before, after, or simultaneously with the preceding and subsequent processes. When performed simultaneously with the preceding and subsequent processes, the preceding and subsequent processes may be performed in an atmosphere having an oxidation capacity (PH₂O/PH₂) of 0.5 to 0.7. By the decarburization, the steel sheet may contain 0.005 wt % or less of carbon, more specifically, 0.003 wt % or less.

After the above-described primary recrystallization annealing step, the steel sheet may contain 0.0130 wt % or more of nitrogen. As will be described later, the steel sheet has a different nitrogen content depending on the thickness, and the above range means an average nitrogen content with respect to the entire thickness.

After the primary recrystallization annealing, the steel sheet may satisfy Expression 5 below.

1≤[G_{1/4t}]−[G_{1/2t}]≤3 [Expression 5]

(In Expression 5, [G_{1/4t}] denotes an average crystal grain size μm measured at ¼ point of the total thickness of the steel sheet, and [G_{1/2t}] denotes average crystal grain size μm measured at ½ point of the total thickness of the steel sheet)

When the crystal grains (G_{1/4t}) in the surface layer grow large, the secondary recrystallization exceeding 5 mm may be less formed, and a very non-uniform secondary recrystallization structure may be formed, resulting in the poor magnetism. Conversely, when the crystal grains (G_{1/4t}) of the surface layer grow too small, a large amount of fine secondary recrystallization of 5 mm or less may be formed, and a large number of secondary recrystallized grains having poor orientation directness may be formed, resulting in the poor magnetism. More specifically, the value of Equation 2 may be 1.2 to 2.7. In this case, the crystal grain size means the crystal grain size measured on a plane parallel to a rolling plane (ND plane).

After the primary recrystallization annealing, the steel sheet may satisfy Expression 3 below.

[Nₜₒₜ]−[N_{1/4t-3/4t}]≤60×(10×[t]−1) [Expression 3]

(In Expression 3, [Nₜₒₜ] denotes the nitrogen content (ppm) in the entire steel sheet, [N_{1/4t-3/4t}] denotes the nitrogen content (ppm) at ¼ to ¾ points of a total thickness of the steel sheet, and [t] denotes a thickness of the cold-rolled sheet (mm).)

When the nitrogen content inside the steel sheet is too small, that is, when the value on the left side of Equation 3 is too large, the grain growth inhibitory force of crystal grains inside may be insufficient, a large number of defects such as nitrogen outlets in the surface layer may occur, and a large amount of fine secondary recrystallization of 5 mm or less may be formed, resulting in the poor magnetism. More specifically, the value on the left side of Equation 3 may be 0.0030 to 0.0060%.

Next, the cold-rolled sheet for which the primary recrystallization annealing has been completed is subjected to the secondary recrystallization annealing. A main object of the secondary recrystallization annealing is to form the {110}<001> texture by the secondary recrystallization, give an insulation property by forming a glass film by an reaction between the oxide layer formed during the decarburnization and MgO, and remove impurities damaging the magnetic characteristics. As a method of secondary recrystallization annealing, in the temperature rising section before the secondary recrystallization occurs, a mixed gas of nitrogen and hydrogen is maintained to protect nitride, which is a grain growth inhibitor, so the secondary recrystallization develops well, and after the completion of the secondary recrystallization, it is maintained for a long time in a 100% hydrogen atmosphere to remove impurities.

In the secondary recrystallization annealing process, the surface oxide layer generated in the primary recrystallization annealing process reacts with the annealing separator to form the base coating layer. The compositions of the base coating layer are distinguished from those of the base steel sheet. For example, when the MgO is used as the annealing separator, forsterite is included.

A ratio of maximum Al luminous intensity to maximum Mg luminous intensity in the base coating layer may be 0.05 to 0.10. The luminous intensity may be analyzed through glow discharge luminescence spectroscopy (GDS), and since this is widely known, a detailed description thereof will be omitted. More specifically, it may be 0.06 to 0.10.

A step of forming an insulating coating layer after secondary recrystallization annealing may be further included. Since a method of forming an insulating coating layer is widely known, a detailed description thereof will be omitted.

In one embodiment of the present invention, since the deviation in the nitrogen content in the thickness direction of the steel sheet is small, the base coating layer is formed uniformly and thinly, and even if the insulating coating layer is formed thinly, appropriate insulation properties may be secured.

In one embodiment of the present invention, by reducing the deviation in the nitrogen content in the thickness direction of the steel sheet, it is possible to form a thin base coating layer after the secondary recrystallization, and may not include an additional step of removing the base coating layer.

The grain oriented electrical steel sheet according to an embodiment of the present invention contains, in weight %, Si: 2.5 to 4.0%, C: 0.005% or less (0% excluded), Al: 0.015 to 0.040%, Mn: 0.04 to 0.15%, S: 0.01% or less (0% excluded), N: 0.0100% or less (0% excluded), and the balance being Fe and other inevitably incorporated impurities. Since the alloy components of the grain oriented electrical steel sheet have been described in the alloy components of the above-described slab, overlapping descriptions thereof will be omitted.

The grain oriented electrical steel sheet according to an embodiment of the present invention may include the base coating layer on the electrical steel sheet substrate.

The ratio of the maximum Al luminous intensity to the maximum Mg luminous intensity in the base coating layer may be 0.05 to 0.10. Since this has been described in the manufacturing method, overlapping descriptions thereof will be omitted.

The core loss (W17/50) of the grain oriented electrical steel sheet may be 0.830 W/kg or less in the condition of 1.7 Tesla and 50 Hz. More specifically, the core loss (W17/500) may be 0.750 to 0.830 W/kg. More specifically, the difference between the maximum and minimum values of the core loss (W17/50) may be 0.050 W/kg or less. The difference between the maximum and minimum values means the difference measured within the entire coil. In this case, the thickness standard may be 0.19 mm.

The magnetic flux density B8 induced under a magnetic field of 800 Nm of the grain oriented electrical steel sheet may be 1.91 T or more. More specifically, it may be 1.91 to 1.95. More specifically, the difference between the maximum and minimum values of the magnetic flux density B8 may be 0.025 T or less. The difference between the maximum and minimum values means the difference measured within the entire coil.

Hereinafter, preferred Examples and Comparative Examples of the present invention are described. However, the following Examples are only preferred embodiments of the present invention, and the present invention is not limited to the following Examples.

### Example

A hot-rolled plate having a thickness of 2.0 mm was manufactured by making A to F slabs having component compositions shown in Table 1 into an ingot by vacuum melting steel containing Fe and other inevitably contained impurities as the remaining components and then heating the ingot at 1150° C. for 210 minutes, followed by hot-rolling. After pickling, the steel was coldrolled once to a thickness of 0.19 mm or 0.14 mm.

The cold-rolled sheet was maintained in a humid atmosphere of 50 v % hydrogen and 50 v % nitrogen and an ammonia mixed gas atmosphere at a temperature of about 800 to 900° C., and was subjected to decarburization and nitriding annealing heat treatment so that the carbon content was 30 ppm or less and the total nitrogen content increased to 130 ppm or more. In this case, a nitriding gas input amount in a preceding process and the nitriding gas input amount in a subsequent process were adjusted as shown in Table 2 below, and the preceding process was performed for 50 seconds and the subsequent process was performed for 70 seconds. After completion of annealing, the thickness of the steel sheet, a total nitrogen amount, and a nitrogen amount in a center (¼ to ¾) in a thickness direction of the steel sheet were summarized in Table 2.

The steel sheet was coated with MgO as an annealing separator, and finally annealed into a coil shape. The final annealing was performed in a mixed atmosphere of 25 v % of nitrogen and 75 v % pf hydrogen up to 1200° C., and after reaching 1200° C., the steel sheet was kept in a 100% hydrogen atmosphere for more than 10 hours and then cooled in a furnace.

Thereafter, an insulating coating layer-forming composition containing a mixed solution of metal phosphate and colloidal silica was applied and heat-treated to form an insulating coating layer having a thickness shown in Table 3 below.

Table 3 summarized maximum and minimum values of magnetic flux density and core loss measured for each condition.

For magnetism, core loss was measured under the conditions of 1.7 Tesla and 50 Hz using a single sheet measurement method, and a size (Tesla) of the magnetic flux density induced under a magnetic field of 800 A/m was measured. In addition, the magnetism was measured for the entire coil, and the maximum and minimum values were summarized in Table 3 below.

TABLE 1

| | | | | | | | | | | Left side of | Left side of |
|---|---|---|---|---|---|---|---|---|---|---|---|
| Component | C | Si | Mn | P | Sn | S | Al | N | Others | Expression 1 | Expression 2 |
| A | 0.06 | 3.3 | 0.08 | 0.03 | 0.07 | 0.004 | 0.0366 | 0.0064 | — | 0.0243 | 5.7 |
| B | 0.06 | 3.2 | 0.07 | 0.04 | 0.06 | 0.005 | 0.0360 | 0.0034 | — | 0.0294 | 10.5 |
| C | 0.05 | 3.3 | 0.06 | 0.03 | 0.06 | 0.004 | 0.0394 | 0.0049 | V:0.003 | 0.030 | 8.0 |
| D | 0.06 | 3.2 | 0.08 | 0.04 | 0.05 | 0.005 | 0.0349 | 0.0054 | Ti:0.003 | 0.0246 | 6.5 |
| E | 0.06 | 3.3 | 0.08 | 0.05 | 0.06 | 0.004 | 0.0306 | 0.0026 | V:0.002 | 0.0256 | 11.7 |
| | | | | | | | | | Ti:0.003 | | |
| F | 0.06 | 3.3 | 0.06 | 0.02 | 0.04 | 0.005 | 0.0376 | 0.0024 | — | 0.033 | 15.9 |
| G | 0.05 | 3.2 | 0.06 | 0.03 | 0.05 | 0.004 | 0.0287 | 0.0035 | — | 0.022 | 8.3 |

TABLE 2

| | | | Total | Nitrogen | | |
|---|---|---|---|---|---|---|
| | Cold rolled | | nitrogen | amount | | |
| | thickness | | amount | in center | Left side of | |
| Component | (mm) | [A]/[B] | (wt %) | (wt %) | Expression 3 | |
| A | 0.19 | 0.17 | 0.0250 | 0.0200 | 50 | Inventive |
| | | | | | | Material 1 |
| B | | 0.21 | 0.0245 | 0.0160 | 85 | Comparative |
| | | | | | | Material 1 |
| C | | 0.16 | 0.0215 | 0.0165 | 50 | Inventive |
| | | | | | | Material 2 |
| D | | 0.13 | 0.0225 | 0.0185 | 40 | Inventive |
| | | | | | | Material 3 |
| E | | 0.1 | 0.0235 | 0.0185 | 50 | Inventive |
| | | | | | | Material 4 |
| F | | 0.08 | 0.0210 | 0.0165 | 45 | Comparative |
| | | | | | | Material 2 |
| A | 0.14 | 0.16 | 0.0235 | 0.0190 | 45 | Comparative |
| | | | | | | Material 3 |
| B | | 0.12 | 0.0200 | 0.0190 | 10 | Inventive |
| | | | | | | Material 5 |
| C | | 0.13 | 0.0200 | 0.0180 | 20 | Inventive |
| | | | | | | Material 7 |
| D | | 0.1 | 0.0210 | 0.0190 | 20 | Inventive |
| | | | | | | Material 8 |
| E | | 0.08 | 0.0190 | 0.0175 | 15 | Inventive |
| | | | | | | Material 9 |
| G | | 0.09 | 0.0200 | 0.0180 | 20 | Comparative |
| | | | | | | Material 4 |

TABLE 3

| | | | Magnetic flux | Magnetic flux | Core loss | Core loss | |
|---|---|---|---|---|---|---|---|
| | | Base coating | density (B8) | density (B8) | (W17/50) | (W17/50) | |
| | Cold rolled | layer Luminous | Minimum | Maximum | Maximum | Minimum | |
| | thickness | intensity ratio | value | value | value | value | |
| Component | (mm) | I(AI)/I(Mg) | (T) | (T) | (W/kg) | (W/kg) | |
| A | 0.19 | 0.08 | 1.91 | 1.92 | 0.818 | 0.798 | Inventive |
| | | | | | | | Material 1 |
| B | | 0.12 | 1.85 | 1.89 | 1.057 | 0.916 | Comparative |
| | | | | | | | Material 1 |
| C | | 0.09 | 1.91 | 1.93 | 0.825 | 0.794 | Inventive |
| | | | | | | | Material 2 |
| D | | 0.07 | 1.91 | 1.93 | 0.815 | 0.790 | Inventive |
| | | | | | | | Material 3 |
| E | | 0.09 | 1.91 | 1.93 | 0.821 | 0.796 | Inventive |
| | | | | | | | Material 4 |
| F | | 0.11 | 1.85 | 1.88 | 1.074 | 0.932 | Comparative |
| | | | | | | | Material 2 |
| A | 0.14 | 0.13 | 1.86 | 1.89 | 0.992 | 0.844 | Comparative |
| | | | | | | | Material 3 |
| B | | 0.09 | 1.91 | 1.92 | 0.788 | 0.759 | Inventive |
| | | | | | | | Material 5 |
| C | | 0.06 | 1.91 | 1.93 | 0.773 | 0.742 | Inventive |
| | | | | | | | Material 7 |
| D | | 0.07 | 1.91 | 1.93 | 0.772 | 0.746 | Inventive |
| | | | | | | | Material 8 |
| E | | 0.10 | 1.91 | 1.93 | 0.776 | 0.740 | Inventive |
| | | | | | | | Material 9 |
| G | | 0.11 | 1.85 | 1.89 | 1.017 | 0.877 | Comparative |
| | | | | | | | Material 4 |

As can be seen in Table 1, the inventive material in which the residual Al is appropriately secured and the process conditions during the primary recrystallization annealing are properly controlled has a uniform nitrogen amount throughout the steel sheet thickness, and the Al strength of the base coating layer is low, so it can be confirmed that the coating adhesion is good and the deviation in core loss and magnetic flux density is small.

On the other hand, when residual Al is not appropriately secured, or when the excessive amount of Al is contained compared to the amount of N, or when the amount of nitrogen is non-uniform throughout the thickness of the steel sheet, the Al strength of the base coating layer is relatively high, so it can be confirmed that the coating adhesion is poor, the core loss and magnetic flux density are poor, and the deviation is large.

The present invention is not limited to the embodiments, but may be manufactured in a variety of different forms, and those of ordinary skill in the art to which the present invention pertains will understand that the present invention may be implemented in other specific forms without changing the technical spirit or essential features of the present invention. Therefore, it should be understood that the above-mentioned embodiments are exemplary in all aspects but are not limited thereto.

1. A method for manufacturing a grain oriented electrical steel sheet, comprising:
hot-rolling a slab to prepare a hot-rolled sheet, the slab containing, in weight %, Si: 2.5 to 4.0%, C: 0.03 to 0.09%, Al: 0.015 to 0.040%, Mn: 0.04 to 0.15%, S: 0.01% or less (0% excluded), N: 0.002 to 0.012%, and the balance being Fe and other inevitably incorporated impurities and satisfying the following Expressions 1 and 2;
cold-rolling the hot-rolled sheet to prepare a cold-rolled sheet;
performing primary recrystallization annealing on the cold-rolled sheet; and
performing secondary recrystallization annealing on the cold-rolled sheet that has been primary recrystallization annealed,
wherein after the primary recrystallization annealing, the following Expression 3 is satisfied.
[Al]−27/14×[N]≥0.0240 [Expression 1]
[Al]/[N]≤14 [Expression 2]
(In Expressions 1 and 2, [Al] and [N] denote the content (wt %) of Al and N in the slab, respectively.)
[Nₜₒₜ]−[N_{1/4t-3/4t}]≤60×(10×[t]−1) [Expression 3]
(In Expression 3, [Nₜₒₜ] denotes the nitrogen content (ppm) in the entire steel sheet, [N_{1/4t-3/4t}] denotes the nitrogen content (ppm) at ¼ to ¾ points of a total thickness of the steel sheet, and [t] denotes a thickness of the cold-rolled sheet (mm).)

2. The method of claim 1, wherein:
the slab further contains 0.002 to 0.01 wt % of at least one of Ti and V alone or in combination thereof.

3. The method of claim 1, wherein:
the slab further contains 0.03 to 0.15 wt % of Sn and Sb in combination, and 0.01 to 0.05 wt % of P.

4. The method of claim 1, wherein:
the slab further contains at least one of Cr: 0.01 wt % or less and Ni: 0.01 wt % or less.

5. The method of claim 1, wherein:
the primary recrystallization annealing includes a preceding process and a subsequent process, and
a nitriding gas input amount A in the preceding process with respect to a total nitriding gas input amount B in the primary recrystallization annealing satisfies Expression 4 below.
0.055≤[A]/[B]≤[t] [Expression 4]
(In Expression 4, a unit of the nitriding gas input is Nm³/hr, and [t] denotes the thickness of the cold-rolled sheet (mm).)

6. The method of claim 5, wherein:
an execution time of the preceding process is 10 to 80 seconds, and an execution time of the subsequent process is 30 to 100 seconds.

7. The method of claim 5, wherein:
the preceding and subsequent processes are performed at a temperature of 800 to 900° C.

8. The method of claim 5, wherein:
the preceding and subsequent processes are performed in an atmosphere having an oxidation ability (PH₂O/PH₂) of 0.5 to 0.7.

9. The method of claim 1, wherein:
after the primary recrystallization annealing, the steel sheet satisfies Expression 5 below.
1≤[G_{1/4t}]−[G_{1/2t}]≤3 [Expression 5]
(In Expression 5, [G_{1/4t}] denotes an average grain size μm measured at ¼ point of the total thickness of the steel sheet, and [G_{1/2t}] denotes average grain size μm measured at ½ point of the total thickness of the steel sheet)

10. The method of claim 1, wherein:
after the secondary recrystallization annealing, the steel sheet satisfies Expression 6 below.
[D_{S}]/[D_{L}]≤0.1 [Expression 6]
(In Expression 6, [D_{S}] denotes the number of crystal grains having a particle diameter of 5 mm or less, and [D_{L}] denotes the number of crystal grains having a particle diameter of more than 5 mm.)

11. The method of claim 1, wherein:
after the secondary recrystallization annealing, a ratio of maximum Al luminous intensity to maximum Mg luminous intensity in the base coating layer is 0.05 to 0.10.

12. A grain oriented electrical steel sheet, comprising:
an electrical steel sheet substrate containing, in weight %, Si: 2.5 to 4.0%, C: 0.005% or less (0% excluded), Al: 0.015 to 0.040%, Mn: 0.04 to 0.15%, S: 0.01% or less (0% excluded), N: 0.0100% or less (0% excluded), and the balance being Fe and other inevitably incorporated impurities and a base coating layer located on the electrical steel sheet substrate,
wherein a ratio of maximum Al luminous intensity to maximum Mg luminous intensity in the base coating layer is 0.05 to 0.10.
